(19) United States
(12) Patent Application Publication
(10) Pub. No.: US 2006/0035512 A1
(43) Pub. Date: Feb. 16, 2006

(54) Electrical branch junction connector

(76) Inventor: Wolfgang Gerberding, Hessisch Oldendorf (DE)

Correspondence Address: SALTER & MICHAELSON;THE HERITAGE BUILDING, 321 SOUTH MAIN STREET, PROVIDENCE, RI, 029037128, US

(21) Appl. No.: 11/196,558

(22) Filed: Aug. 3, 2005

(30) Foreign Application Priority Data
Aug. 4, 2004 (DE) 10 2004 037 997.1

(51) Int. Cl. H01R 4/24

(52) U.S. Cl. 439/411

(57) ABSTRACT

The invention relates to a branch junction connector for self-stripping electrical contact of cable wires of electrical lines. It is proposed that, for this purpose, an advancing rotating cylinder be used, which is joined, via a rotating thrust bearing, with a contact tap element that is guided in a linear manner in an insulation housing in such a manner as to be rotationally rigid and to withstand pulling and pushing.

### TECHNICAL FIELD

The invention relates to a branch junction connector for producing a self-stripping electrical contacting of cable wires of electrical lines that have insulation and/or sheathing and the respective tap zones of which are held in a fixed position parallel to one another in an insulation housing, whereby the contact tap per cable occurs in each case by means of a contact tap element in the insulation housing that can move in a guided manner perpendicular to the cable and that cuts through the insulation and/or sheathing and contacts the cable wires.

### BACKGROUND DISCUSSION

Such branch junction connectors are known for making electrical contact of power supply cables (phase leads, neutral leads, earth leads) as well as for making branch contact of data cables, control cables, etc. The cables can exist as parallel single cables or they can be in the form of a flat ribbon cable having a defined wire-to-wire spacing. It is always the case that they are held in fixed position parallel to one another in the insulation housing of the branch junction connector in the region of their tap zones used for the branching.

Diverse design forms are known as contact tap elements for such branch junction connectors. In practice, fork-shaped insulation displacement contacts have become predominant (see U.S. Pat. No. 5,059,137). In addition, there are needle-shaped piercing contacts or other contact tap elements furnished with a contact point, such as, for example, pins that either are pierced into the cables being contacted without twisting or else are screwed into the cables being contacted by means of a multiturn thread (for this, see the embodiments described in DE 101 33 659 A1).

The contacting of cable wires with the aid of a pointed-head contact screw, the tip of which is suitable for piercing the insulation and/or the sheathing of a cable is also known (see DE AS [Examined] 2,206,786 and DE 4,402,837 C2).

All of these embodiments of contact tap elements have been developed in order to make possible a simple and quick installation of the generic branch junction connector. Here, the advantage of rapid contact is afforded particularly for those designs in which several contact tap elements, assigned to various cable wires, are arranged together in fixed position on a pressure plate and are pressed simultaneously in a single operation, without being twisted, into all of the cables being contacted. However, the forces that need to be applied for this are as a rule very large and cannot be produced by an electrical installer without auxiliary tools. In practice, therefore, the electrical installer prefers branch junction connectors that each allow a contacting to be made between the respective cables by means of a single contact screw that can be screwed in. Although this necessitates a large number of screwing operations requiring intensive twisting for making a contact of all cables, it has the advantage that, in manual terms, it requires the electrical installer to apply less force. However, a drawback is that a screwing technology of this kind may be used only for needle-shaped piercing contacts or for other needle-shaped contacts of the piercing type.

### SUMMARY OF THE INVENTION

The object of the present invention consists of developing a branch junction connector of the generic kind that may be used universally for all kinds of contact tap elements and that, at the same time, can be quickly and easily installed by the electrical installer.

This object is solved in accordance with the invention in that the head of the contact tap element has a circular rotating thrust bearing for an advancing rotating cylinder that has a transport thread and is rotatably mounted in the insulation housing and that the contact tap element is mounted in the insulation housing in a rotationally rigid manner, but its rotating thrust bearing is joined with the advancing rotating cylinder in a rotatable manner in such a way that, between the advancing rotating cylinder and the rotating thrust bearing, a connection that withstands pushing and pushing exists in the direction of movement of the contact tap element.

The teaching of the invention makes possible two key advantages at the same time. The decoupling, in accordance with the invention, of the driving motion of the contact tap element from the contact tap element itself has the consequence that now the driving motion, in the form of the proposed advancing rotating cylinder, can be adapted substantially better than previously to manual handling by the electrical installer and that, at the same time, the contact tap element is fundamentally rigid to rotation, but its movement can nonetheless be guided in a linear manner in the insulation housing, so that the contact tap element can be provided with all kinds of contacts known up to now for the cable tap and, namely, with those that have to be pressed against cables being contacted without being twisted and that, if need be, also have to be pulled back off the contacted cable.

An especially advantageous embodiment of the invention is characterized according to claim 2 in that the advancing rotating cylinder is constructed in the form of a cylinder cap with an open face, which engages over the rotating thrust bearing of the contact tap element, whereby the cylinder wall of the cylinder cap springs back and engages with an inward-projecting edge in a ring groove of the rotating thrust bearing and that, then, the transport thread engages between the cylinder cap and the insulation housing and, in this way, the cylinder wall of the cylinder cap is blocked from springing back again.

The new cylinder cap, which overlaps the contact tap element, makes possible a short axial design of the assembly consisting of cylinder cap and contact tap element. The desired block to the springing back of the cylinder cap is achieved in principle when the premounted assembly is inserted a short distance into the cylinder bore, which, for each contact tap element, is present in the insulation housing of the branch junction connector. The final block to the springing back is then assured when the cylinder cap is screwed with its external thread into the inner thread of the cylinder bore in the insulator housing in a form-fitting manner. The cylinder cap with the contact tap element is then situated in the position of use.

It is appropriate to furnish the cylinder bore with a left-rotation stop, which passes over the cylinder cap by “snapping over” at the beginning when it is screwed into the cylinder bore and which prevents the cylinder cap from being unscrewed unintentionally back out of the cylinder bore by rotation to the left.

A cylinder cap of the kind according to the invention is guided into the form-fitting housing cylinder bore in an extremely stable manner and can be handled in a robust manner by the electrical installer. Its cap head can have molded insertion sockets for a screwdriver or for another tool.

The transport thread between the cylinder cap and the housing cylinder bore is preferably constructed with one turn according to claim 4, whereby particular advantages can then be achieved in regard to the manual handling of the rotating advance of the cylinder cap and in regard to the fabrication (=the housing cylinder bores produced by plastic injection molding technology can be ejected from the mold) when the thread is formed as a thread groove on the side of the cylinder cap, this thread groove being formed as a depression in the cylinder wall of the cylinder cap, whereas the thread on the side of the housing cylinder bore is formed in a projecting manner and consists of two opposite-lying parts, each of which has a circumferential extension smaller than 180°, preferably about 120°.

As a result, the cylinder cap of the kind in accordance with the invention can be handled quickly and simply with a 120° advancing rotation by the electrical installer and it affords nonetheless, when the pitch of the thread parts is appropriate, an adequately large linear advance for the contact tap element, which is guided in a linear and rotationally rigid manner into the respective housing cylinder bore of the insulation housing of the branch junction connector.

The contact tap element, according to claim 5, can be produced as a plastic injection-molded part and consists of a plastic body, which has a bottom-side insertion socket into which a contact, made of metal, is locked for making an electrical contact with cable wires in such a manner that it is rotationally rigid and is able to withstand pulling or pushing. The metallic contacts can be constructed as needle-shaped piercing contacts or as fork-shaped insulation displacement contacts or as contacts of any other known design.

For branch junction connectors of the generic kind, the contact tap elements of which are furnished with a forked-shape insulation displacement contact produced from flat material, it is proposed, as a further idea of the invention, that the forked-shape insulation displacement contact be guided during its translational movement by means of a guide piece, which is molded from the material of the insulation housing and which is positioned in the insulation housing in an axis-parallel and essentially center-symmetrical manner and above the cable wires being contacted in such a way that the forked-shaped opening of the insulation displacement contact engages over the guide piece and is guided by the guide piece before the insulation displacement contact comes into contact with the insulation and/or the sheathing of the cable running beneath the guide piece.

The proposed guide piece is of substantial advantage when one and the same branch junction connector is to be used for making contact between electrical cables with a specific larger ribbon width of the lead cross sections (e.g., for lead cross sections of 2.5 mm² to 4.0 mm²). When this is done, it is also important that, for a flat ribbon cable, the spacing tolerances of the individual cables, which vary from manufacturer to manufacturer, are taken into consideration. This is possible with the aid of the proposed guide pieces, which can be produced by injection molding technology very precisely in the insulation housing of the branch junction connector and which guarantee a corresponding guiding of the respective insulation displacement contacts in a positionally precise manner.

A further improvement is achieved for a branch junction connector of the invention according to claim 9 in that, when the fork-shaped insulation displacement contact is guided during its translational movement by means of an edge busbar, which is made of a flat metallic material that extends in a plane of extension parallel to the translational movement of the insulation displacement contact, whereby the edge busbar is held in a positionally fixed manner in the insulation housing and a U-shaped leaf spring clamp that opens downward in the direction of motion of the insulation displacement contact is engaged over this, the spring clamp being joined electrically and mechanically with the insulation displacement contact and being carried along as a sliding contact during movement of the insulation displacement contact on the edge busbar.

If, for a branch junction connector, the aforementioned edge busbars are combined with the previously mentioned guide pieces in such a way that the plane of extension of the respective edge busbar and the plane of the guide piece, which is defined by the axis of the respective guide piece and the axis of the cable wires being contacted, cross at right angles, there results, in the intersection line of the planes meeting each other at 90°, a precisely tracked cross guide for the respective contact tap element.

### DETAILED DESCRIPTION OF THE DRAWINGS

It should be understood that the drawings are provided for the purpose of illustration only and are not intended to define the limits of the disclosure. The foregoing and other objects and advantages of the embodiments described herein will become apparent with reference to the following detailed description when taken in conjunction with the accompanying drawings in which:

Embodiment examples of the invention will be described below on the basis of the drawings. Shown therein are the following:

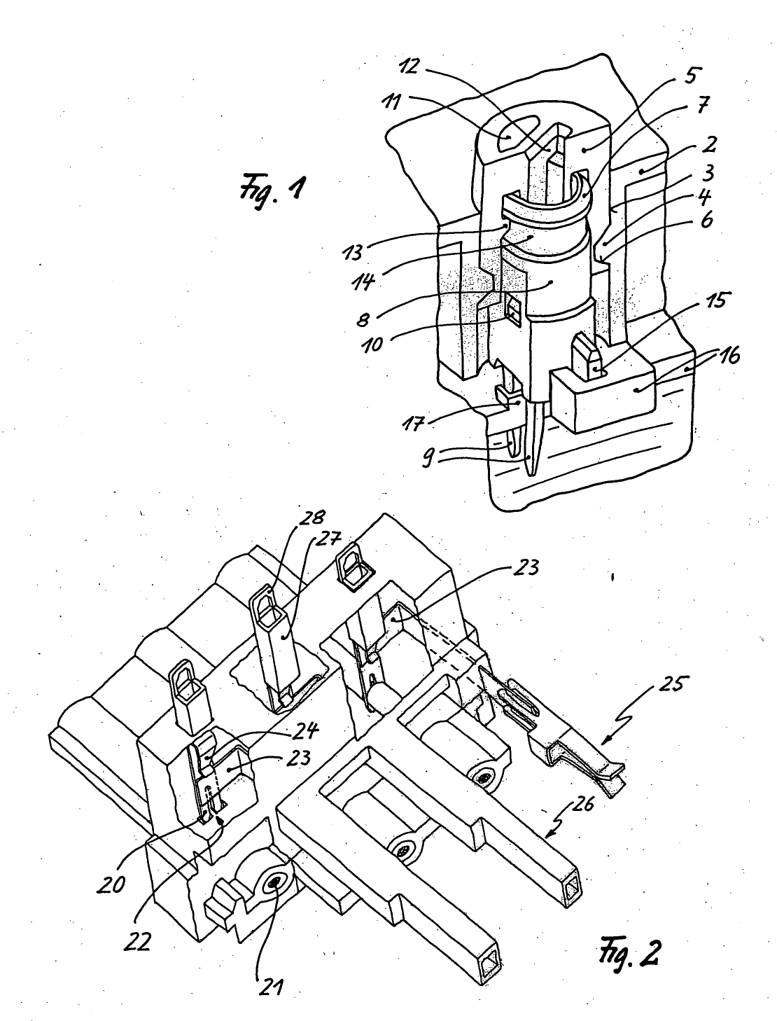

FIG. 1 a first embodiment example in perspective depiction,

FIG. 2 a second embodiment example in perspective depiction.

### DETAILED DESCRIPTION

FIG. 1 shows, in perspective depiction, the region of a contact tap element, of which there are several for a branch junction connector of the invention. Depicted is the insulation housing 2 with the housing cylinder bore 3, which has a projecting, one-turn thread 4, preferably consisting of two opposite-lying parts, each with a circumferential extension of 120° (not shown individually).

In the housing cylinder bore, in accordance with the teaching of the invention, a cylinder cap 5 is inserted and screwed onto the thread 4 of the cylinder bore. For this purpose, the thread on the side of the cylinder cap is formed as a depression as a thread groove 6 on the bottom edge of the cylinder wall of the cylinder cap.

The cylinder cap overlaps the rotating thrust bearing 7 of the contact tap element, which, in the case of the embodiment example depicted, consists of the plastic body 8 with the rotating thrust bearing 7 and a bottom-side, fork-shaped insulation displacement contact 9 made of a flat piece of metal. The insulation displacement contact 9 locks in a bottom-side insertion socket of the plastic body 8 in such a manner as to be rotationally rigid as well as to withstand pulling and pushing, namely, by means of the locking device 10.

When the cylinder cap 5 and the contact tap elements 7, 8, 9 are premounted, the inward-projecting edge 13 of the cylinder cap engages in the ring groove 14 of the contact tap element. For this purpose, the cylinder wall of the cylinder cap can spring back somewhat, this being made possible, on the one hand, by the material weakening in the lower edge region (see depressed thread groove 6) and, on the other hand, by cavities 11 and 12 in the upper cap region. The cavity 12, at the same time, is the insertion socket for the tip of a screwdriver, by means of which the cylinder cap 5 can be rotated.

The plastic body 8 of the contact tap element is guided in a rotationally rigid manner by means of the molded rotational stop 15 in the floor 16 of the insulation housing. By means of a twisting or rotation of the cylinder cap, the contact tap element is moved in a linear fashion and (in the depiction of FIG. 1) downward against an electrical cable, which is situated beneath the floor 16 and is held there in a positionally fixed position in the insulation housing of the branch junction connector.

As a result of the locking of the inner edge 13 of the cylinder cap in the ring groove 14 of the contact tap element in a manner so as to withstand pulling and pushing, it is possible without any problem for the electrical installer to push the insulation displacement contact onto a cable being contacted and to pull the insulation displacement contact back off of the cable once again.

The positionally precise guiding of the insulation displacement contact 9 is improved by having the fork-shaped opening of the insulation displacement contact engage over a guide piece 17, which is also molded in the insulation housing in a positionally precise fashion during the injection molding of the insulation housing.

FIG. 2 shows an embodiment example of the invention according to claims 8 and 9.

The movement of the fork-shaped insulation displacement contact 20 against the cable 21, which is held in a positionally fixed manner in the bottom part of the insulation housing, is guided by means of the guide piece 22 in the upper part of the insulation housing. This guide is completed to form a precisely tracked cross guide by the additional mounting of an edge busbar 23 in the insulation housing in a positionally fixed manner, this busbar being overlapped in the direction of motion by a downward-opening U-shaped leaf spring 24 (in the depiction of FIG. 2), which is firmly joined electrically and mechanically with the insulation displacement contact and which moves as well on the edge busbar as a sliding contact when the insulation displacement contact is moved (compare to this the respective translational positions in the case of the neighboring depicted contact tap elements).

The respective edge busbars 23 each end in a socket contact 25, which is arranged inside of an insulation plug 26 of the branch junction connector. The insulation displacement contact is pushed onto the respective edge busbar, in the embodiment example depicted, by means of an insulation sliding collar 27, which can move linearly in the direction of motion and which has a pulling tab 28, so that, even with such a simple insulation sliding collar, it is possible to push and pull the respective insulation displacement contact onto and off of, respectively, the cable being contacted.

1) A branch junction connector
for self-stripping electrical contact of cable wires of electrical lines that have insulation and/or sheathing and the respective tap zones of which are held in a fixed position parallel to one another in an insulation housing,
whereby the contact tap per cable occurs in each case by means of a contact tap element that can move in a guided manner perpendicular to the cable in the insulation housing and that cuts through the insulation and/or sheathing and contacts the cable wires,
wherein
the head of the contact tap element has a circular rotating thrust bearing for an advancing rotating cylinder that has a transport thread and is rotatably mounted in the insulation housing,
and that the contact tap element is mounted in the insulation housing in a rotationally rigid manner, but its rotating thrust bearing is joined with the advancing rotating cylinder in a rotatable manner in such a way that, between the advancing rotating cylinder and the rotating thrust bearing, a connection that withstands pulling and pushing exists in the direction of movement of the contact tap element.

2) The branch junction connector according to claim 1, wherein the advancing rotating cylinder is constructed in the form of a cylinder cap with an open face, which engages over the rotating thrust bearing of the contact tap element,
whereby the cylinder wall of the cylinder cap springs back and engages with an inward-projecting edge in a ring groove of the rotating thrust bearing,
and that, then, the transport thread engages between the cylinder cap and the insulation housing and, in this way, the cylinder wall of the cylinder cap is blocked from springing back again.

3) The branch junction connector according to claim 2, wherein the cylinder cap is made of plastic and that, in the upper region, the cylinder cap has a material weakening (e.g., in the form of cavities and/or wall perforations), which favor the springing back of the cylinder wall of the cylinder cap when it is engaged over the rotating thrust bearing.

4) The branch junction connector according to claim 1, wherein the transport thread is constructed as a single turn and in that the thread is formed as a thread groove on the side of the cylinder cap, this thread groove being formed as a depression in the cylinder wall of the cylinder cap,
whereas the thread on the side of the housing cylinder bore is formed in a projecting manner and consists of two opposite-lying parts, each of which has a circumferential extension smaller than 180°, preferably about 120°.

5) The branch junction connector according to claim 1, wherein the contact tap element consists of a plastic body, which has a bottom-side insertion socket into which a contact, made of metal, locks, for making electrical contacts of cable wires in such a manner as to be rotationally rigid as well as to withstand pulling or pushing.

6) The branch junction connector according to claim 5, wherein the contact is a needle-shaped piercing contact.

7) The branch junction connector according to claim 5, wherein the contact is a forked-shaped insulation displacement contact.

8) A branch junction connector
for self-stripping electrical contact between cable wires of electrical lines that have insulation and/or sheathing and the respective tap zones of which are held in a fixed position parallel to one another in an insulation housing,
whereby the contact tap per cable occurs in each case by means of a contact tap element that can move in a guided manner perpendicular to the cable in the insulation housing and that is constructed in the form of a fork-shaped insulation displacement contact made of a flat material,
wherein
the forked-shaped insulation displacement contact is guided during its translational movement by means of a guide piece, which is molded from the material of the insulation housing and which is positioned in the insulation housing in an axis-parallel and essentially center-symmetrical manner and above the cable wires being contacted,
in such a way that the forked-shaped opening of the insulation displacement contact engages over the guide piece and is guided by the guide piece before the insulation displacement contact comes into contact with the insulation and/or the sheathing of the cable running beneath the guide piece.

9) A branch junction connector
for self-stripping electrical contact of cable wires of electrical lines that have insulation and/or sheathing and the respective tap zones of which are held in a fixed position parallel to one another in an insulation housing,
whereby the contact tap per cable occurs in each case by means of a contact tap element that can move in a guided manner perpendicular to the cable in the insulation housing and that is constructed in the form of a fork-shaped insulation displacement contact made of a flat material,
wherein
the fork-shaped insulation displacement contact is guided during its translational movement by means of an edge busbar, which is made of a flat metal material that extends in a plane of extension parallel to the translational movement of the insulation displacement contact,
whereby the edge busbar is held in a positionally fixed manner in the insulation housing and a U-shaped leaf spring clamp that opens downward in the direction of motion of the insulation displacement contact is engaged over this, the spring clamp being joined electrically and mechanically with the insulation displacement contact and being carried along as a sliding contact during movement of the insulation displacement contact on the edge busbar.

10) The branch junction connector according to claim 9,
wherein
the fork-shaped insulation displacement contact is guided by means of the edge busbar,
and wherein the fork-shaped insulation displacement contact is guided in addition during its translational movement by means of a guide piece, which is moulded from the material of the insulation body,
and wherein the plane of extension of the edge busbar and the plane of the guide piece, which is defined by the axis of the guide piece and the axis of the cable wires being contacted, cross at right angles.

11. The branch junction connector according to claim 8, wherein the head of the contact tap element has a circular rotating thrust bearing for an advancing rotating cylinder that has a transport thread and is rotatably mounted in the insulation housing,
and that the contact tap element is mounted in the insulation housing in a rotationally rigid manner, but its rotating thrust bearing is joined with the advancing rotating cylinder in a rotatable manner in such a way that, between the advancing rotating cylinder and the rotating thrust bearing, a connection that withstands pulling and pushing exists in the direction of movement of the contact tap element.

12. The branch junction connector according to claim 11 wherein the advancing rotating cylinder is constructed in the form of a cylinder cap with an open face, which engages over the rotating thrust bearing of the contact tap element,
whereby the cylinder wall of the cylinder cap springs back and engages with an inward-projecting edge in a ring groove of the rotating thrust bearing,
and that, then, the transport thread engages between the cylinder cap and the insulation housing and, in this way, the cylinder wall of the cylinder cap is blocked from springing back again.

13. The branch junction connector according to claim 12, wherein the cylinder cap is made of plastic and that, in the upper region, the cylinder cap has a material weakening (e.g., in the form of cavities and/or wall perforations), which favor the springing back of the cylinder wall of the cylinder cap when it is engaged over the rotating thrust bearing.

14. The branch junction connector according to claim 11, wherein the transport thread is constructed as a single turn and in that the thread is formed as a thread groove on the side of the cylinder cap, this thread groove being formed as a depression in the cylinder wall of the cylinder cap,
whereas the thread on the side of the housing cylinder bore is formed in a projecting manner and consists of two opposite-lying parts, each of which has a circumferential extension smaller than 180°, preferably about 120°.

15. The branch junction connector according to claim 11, wherein the contact tap element consists of a plastic body, which has a bottom-side insertion socket into which a contact, made of metal, locks, for making electrical contacts of cable wires in such a manner as to be rotationally rigid as well as to withstand pulling or pushing.

16. The branch junction connector according to claim 15, wherein the contact is a needle-shaped piercing contact.

17. The branch junction connector according to claim 9, wherein the head of the contact tap element has a circular rotating thrust bearing for an advancing rotating cylinder that has a transport thread and is rotatably mounted in the insulation housing,
and that the contact tap element is mounted in the insulation housing in a rotationally rigid manner, but its rotating thrust bearing is joined with the advancing rotating cylinder in a rotatable manner in such a way that, between the advancing rotating cylinder and the rotating thrust bearing, a connection that withstands pulling and pushing exists in the direction of movement of the contact tap element.

18. The branch junction connector according to claim 17, wherein the advancing rotating cylinder is constructed in the form of a cylinder cap with an open face, which engages over the rotating thrust bearing of the contact tap element,
whereby the cylinder wall of the cylinder cap springs back and engages with an inward-projecting edge in a ring groove of the rotating thrust bearing,
and that, then, the transport thread engages between the cylinder cap and the insulation housing and, in this way, the cylinder wall of the cylinder cap is blocked from springing back again.

19) The branch junction connector according to claim 18, wherein the cylinder cap is made of plastic and that, in the upper region, the cylinder cap has a material weakening (e.g., in the form of cavities and/or wall perforations), which favor the springing back of the cylinder wall of the cylinder cap when it is engaged over the rotating thrust bearing.

20) The branch junction connector according to claim 17, wherein the transport thread is constructed as a single turn and in that the thread is formed as a thread groove on the side of the cylinder cap, this thread groove being formed as a depression in the cylinder wall of the cylinder cap,
whereas the thread on the side of the housing cylinder bore is formed in a projecting manner and consists of two opposite-lying parts, each of which has a circumferential extension smaller than 180°, preferably about 120°.

21) The branch junction connector according to claim 17, wherein the contact tap element consists of a plastic body, which has a bottom-side insertion socket into which a contact, made of metal, locks, for making electrical contacts of cable wires in such a manner as to be rotationally rigid as well as to withstand pulling or pushing.

22) The branch junction connector according to claim 21, wherein the contact is a needle-shaped piercing contact.
